(19) United States
(12) Patent Application Publication
(10) Pub. No.: US 2006/0248000 A1
(43) Pub. Date: Nov. 2, 2006

(54) Shared home ownership contracts and methods for securitizing same

(75) Inventors: Paul Kent Graeve, Chicago, IL (US); Bradley J. McGill, Birmingham, AL (US)

Correspondence Address: Daniel H. Golub, 1701 Market Street, Philadelphia, PA, 19103, US

(73) Assignee: Delta Rangers, Inc., Birmingham, AL (US)

(21) Appl. No.: 11/116,146

(22) Filed: Apr. 27, 2005

(51) Int. Cl. G06Q 40/00

(52) U.S. Cl. 705/38

(57) ABSTRACT

A method for creating, selling and servicing a contract for financing a homeowner's residential real estate property. The homeowner supplies a down-payment to fund a first portion of the purchase price of the homeowner's residential real estate property. A mortgage funds a second portion of the purchase price. The contract provides equity participation to a contract holder in the homeowner's residential real estate property in return for the contract holder funding a third portion of the purchase price. A total purchase price of the residential real estate property comprises a sum of the first portion, the second portion and the third portion.

### FIELD OF THE INVENTION

The present invention relates to a method for creating, selling and servicing a contract for financing a homeowner's residential real estate property.

### BACKGROUND OF THE INVENTION

The value of residential real estate and land in the United States accounts for more than half of the national wealth. Homeownership has always been part of the “American Dream,” and it is an important societal goal. With the steadily rising values of housing markets, a home represents the largest single asset for most individuals, and the associated accumulated equity in the home constitutes a substantial part of their financial net worth.

Despite the sophistication of the financial markets in the United States, there is still no financial product designed to allow home owners to share equity interests in their homes with investors, in a way that permits both the homeowners and the investors to share in appreciation of residential real estate. Owners of residential real estate and investors would benefit greatly from a financial instrument that provided for such shared home ownership.

### SUMMARY OF THE INVENTION

The present invention is directed to a method for creating, selling and servicing a contract for financing a homeowner's residential real estate property. The homeowner supplies a down-payment to fund a first portion of the purchase price of the homeowner's residential real estate property. A mortgage funds a second portion of the purchase price. The contract provides equity participation to a contract holder in the homeowner's residential real estate property in return for the contract holder funding a third portion of the purchase price. A total purchase price of the residential real estate property comprises a sum of the first portion, the second portion and the third portion.

A contract is executed between the homeowner and a mortgage originator. The contract includes a requirement that the homeowner supplies a down-payment to fund the first portion of the purchase price, and a mortgage for financing the second portion of the purchase price. In exchange for the mortgage, the contract imposes a first obligation on the homeowner to make periodic mortgage payments to the contract holder during a period between execution of the contract and a future time.

The contract also provides that an initial equity participation payment is supplied by the mortgage originator for funding the third portion of the purchase price. In exchange for the initial equity participation payment, a second obligation is imposed on the homeowner to make a future equity participation payment to the contract holder at the future time. The future equity participation payment has an amount comprising the initial equity participation payment plus a predetermined percentage of an increase in value of the residential real estate property between a time of execution of the contract and the future time. In exchange for the initial equity participation payment, a third obligation is optionally imposed on the homeowner to make periodic equity participation finance payments to the contract holder during the period between execution of the contract and the future time.

As part of the contract, the homeowner grants at least one lien on the homeowner's residential real estate property to the contract holder in order to secure at least one of: the first obligation, the second obligation and the third obligation.

The mortgage originator creates a security by pooling rights under the contract with rights under other contracts sold to a plurality of other homeowners each of whom owns at least one of a plurality of residential real estate properties. The security is sold to an institutional investor in a secondary market, and provides the institutional investor with at least one of: (i) a right to receive the periodic mortgage payments from each of the homeowners, (ii) a right to receive the periodic equity participation finance payments from each of the homeowners; and (iii) for each of the plurality of residential real estate properties, a right to receive the future equity participation payment associated with the residential real property at the time of a future sale of the residential real estate property.

The plurality of contracts included in the security are serviced by managing at least one of: the periodic mortgage payments, the periodic equity participation finance payments, and the equity participation payments from the homeowners. The servicing is performed in exchange for a servicing fee.

In one embodiment, the security provides the institutional investor with a right to receive the periodic mortgage payments from each of the homeowners, the periodic equity participation finance payments from each of the homeowners, and for each of the plurality of residential real estate properties, the right to receive the future equity participation payment associated with the residential real property at the time of the future sale of the residential real estate property.

In a further embodiment, first and second securities are created by pooling rights under the contract with rights under other contracts sold to a plurality of other homeowners each of whom owns at least one of a plurality of residential real estate properties, and selling the first and second securities, respectively, to first and second different institutional investor in a secondary market. The first security provides the first institutional investor with a right to receive the periodic mortgage payments from each of the homeowners. The second security provides the second institutional investor with the right to receive the periodic equity participation finance payments from each of the homeowners, and for each of the plurality of residential real estate properties, the right to receive the future equity participation payment associated with the residential real property at the time of the future sale of the residential real estate property. In one version of this further embodiment, after execution of the contract, the homeowner periodically makes a single payment that includes both one of the periodic mortgage payments and one of the periodic equity participation finance payments, and a servicing agent disburses a portion of the single payment covering the mortgage payment to the first institutional investor and a portion of the single payment covering the equity participation finance payment to the second institutional investor.

In accordance with a further aspect, for each of the plurality of residential real estate properties, sale proceeds are split at the time of the future sale to cover the first obligation and the third obligation of the homeowner of the residential real estate property.

In a still further embodiment, the homeowner pledges a portion of the homeowner's down-payment in the residential real estate property to the contract holder as security in the event that the homeowner's residential real estate is later sold at a loss. Optionally, the homeowner purchases a second contract having a premium payable by the homeowner, an expiration date that is a date certain, a predetermined strike threshold, and a fixed cash-settled payout triggered by a reduction in value of a residential real estate index below the predetermined strike threshold between a first time and the expiration date; wherein the index benchmarks at least one characteristic of a plurality of residential real estate properties of the same type as the homeowner's property and in a common geographic area as the homeowner's property. A further security is created by pooling the second contract with other contracts sold to a second plurality of homeowners, and selling the further security to a further institutional investor in a secondary market. The further institutional investor receives at least a portion of the premium paid by the second plurality of homeowners, and the homeowner receives the fixed cash-settled payout from the further institutional investor if the value of the index decreases below the predetermined strike threshold between the first time and the expiration date. The homeowner may use the second contract as a hedge to offset potential losses to the homeowner that would result if the homeowner's residential real estate is later sold at a loss.

### BRIEF DESCRIPTION OF THE DRAWINGS

FIG. 1 is a schematic showing a method for creating, selling and servicing a contract for financing a homeowner's residential real estate property, in accordance with a first embodiment of the present invention.

FIG. 2 is a schematic showing a method for creating, selling and servicing a contract for financing a homeowner's residential real estate property, in accordance with a second embodiment of the present invention.

### DETAILED DESCRIPTION OF THE PREFERRED EMBODIMENTS

For purposes of this application, “residential real estate” means owner-occupied residential dwellings, including but not limited to houses, townhouses, condominiums, owned apartments, and co-ops.

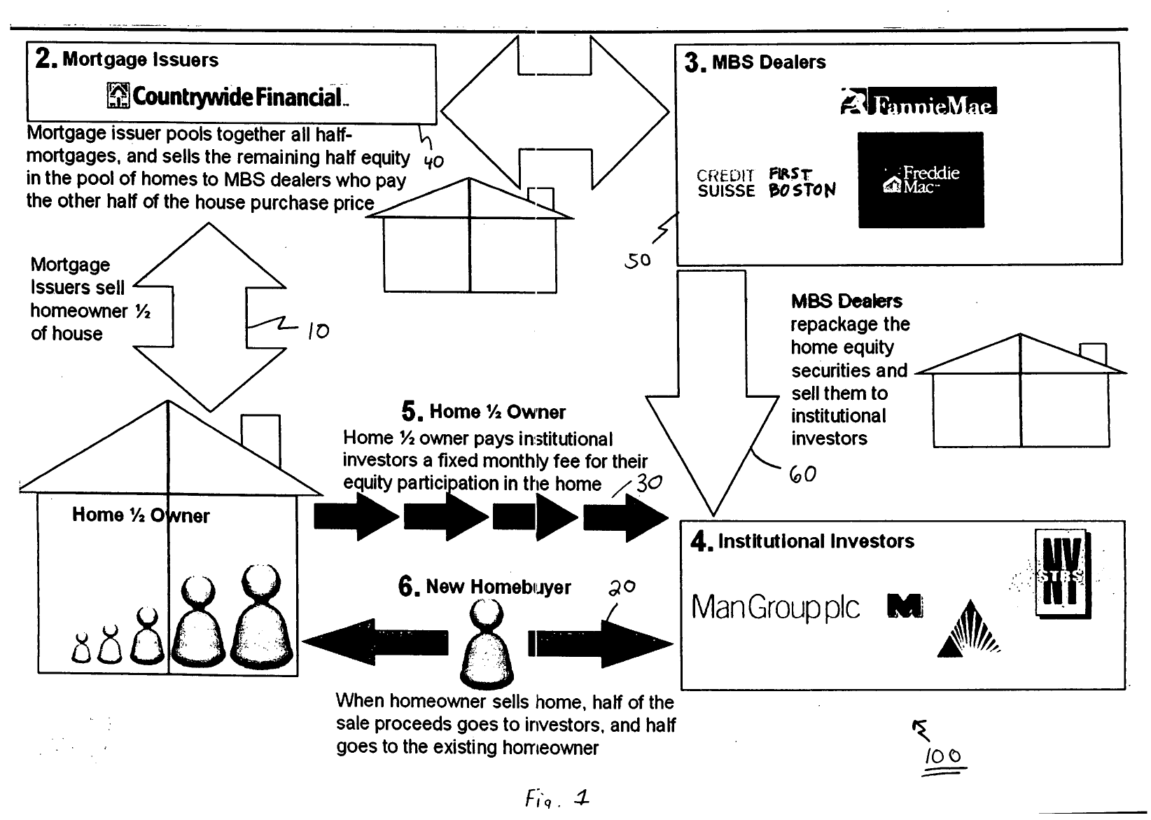

Referring now to FIG. 1, there is shown a schematic of a method for creating, selling and servicing a contract for financing a homeowner's residential real estate property, in accordance with a first embodiment of the present invention. In step 10, the homeowner supplies a down-payment to fund a first portion of the purchase price of the homeowner's residential real estate property, and a mortgage funds a second portion of the purchase price. In the example shown in FIG. 1, the first and second portions of the purchase price together equal half of the purchase price of the home. It will be understood that the first and second portions may correspond to other percentages of the purchase price of the home.

The contract that is the subject of the present invention provides equity participation to a contract holder in the homeowner's residential real estate property in return for the contract holder funding a third portion of the purchase price (e.g., 50% of the purchase price as shown in FIG. 1). The total purchase price of the residential real estate property this corresponds to a sum of the first portion, the second portion and the third portion.

Referring still to FIG. 1, in step 10 the contract is executed between the homeowner and a mortgage originator. The contract includes a requirement that the homeowner supplies a down-payment to fund the first portion of the purchase price, and a mortgage for financing the second portion of the purchase price. In exchange for the mortgage, the contract imposes a first obligation on the homeowner to make periodic mortgage payments to the contract holder during a period between execution of the contract and a future time (e.g., when the home is sold).

The contract also provides that an initial equity participation payment is supplied by the mortgage originator for funding the third portion of the purchase price. In exchange for the initial equity participation payment, a second obligation is imposed on the homeowner to make a future equity participation payment 20 to the contract holder at the future time. The future equity participation payment corresponds to the initial equity participation payment plus a predetermined percentage (e.g., 50% in the example of FIG. 1) of the increase in value of the residential real estate property between the time of execution of the contract and the future time. In exchange for the initial equity participation payment, a third obligation is optionally imposed on the homeowner to make periodic equity participation finance payments 30 to the contract holder during the period between execution of the contract and the future time.

As part of the contract, the homeowner grants at least one lien on the homeowner's residential real estate property to the contract holder in order to secure one or more of the first, second third obligations.

In step 40, a security is created by pooling rights under the contract with rights under other contracts sold to a plurality of other homeowners each of whom owns at least one of a plurality of residential real estate properties. In one embodiment, step 40 is performed by one or more large mortgage issuance providers such as Countrywide Mortgage or Washington Mutual. The security is repackaged (step 50) and sold (step 60) to an institutional investor in a secondary market. In one embodiment, step 50 is performed by one or more mortgage backed securities issuers such as Fannie Mae or Freddie Mac.

The security provides the institutional investor with at least one of: (i) a right to receive the periodic mortgage payments from each of the homeowners, (ii) a right to receive the periodic equity participation finance payments from each of the homeowners; and (iii) for each of the plurality of residential real estate properties, a right to receive the future equity participation payment associated with the residential real property at the time of a future sale of the residential real estate property. Securities sold in step 60 may be categorized into types according to risk profile, geographic exposure, home price, exposure, duration, etc.

The plurality of contracts included in the security are serviced by managing at least one of: the periodic mortgage payments, the periodic equity participation finance payments, and the equity participation payments from the homeowners. The servicing is performed in exchange for a servicing fee.

In one embodiment, the security sold to the institutional investor in step 60 provides the institutional investor with a right to receive the periodic mortgage payments from each of the homeowners, the periodic equity participation finance payments 30 from each of the homeowners, and for each of the plurality of residential real estate properties, the right to receive the future equity participation payment 20 associated with the residential real property at the time of the future sale of the residential real estate property.

In a further embodiment, first and second securities are created and sold to institutional investors in steps 50 and 60 by pooling rights under the contract with rights under other contracts sold to a plurality of other homeowners each of whom owns at least one of a plurality of residential real estate properties, and selling the first and second securities, respectively, to first and second different institutional investor in a secondary market. The first security provides the first institutional investor with a right to receive the periodic mortgage payments from each of the homeowners. The second security provides the second institutional investor with the right to receive the periodic equity participation finance payments 30 from each of the homeowners, and for each of the plurality of residential real estate properties, the right to receive the future equity participation payment 20 associated with the residential real property at the time of the future sale of the residential real estate property. In one version of this further embodiment, after execution of the contract, the homeowner periodically makes a single payment that includes both one of the periodic mortgage payments and one of the periodic equity participation finance payments 30, and a servicing agent disburses a portion of the single payment covering the mortgage payment to the first institutional investor and a portion of the single payment covering the equity participation finance payment 30 to the second institutional investor.

In a further embodiment, the homeowner pledges a portion of the homeowner's down-payment in the residential real estate property to the contract holder as security in the event that the homeowner's residential real estate is later sold at a loss. Optionally, the homeowner purchases a second contract having a premium payable by the homeowner, an expiration date that is a date certain, a predetermined strike threshold, and a fixed cash-settled payout triggered by a reduction in value of an index below the predetermined strike threshold between a first time and the expiration date; wherein the index benchmarks at least one characteristic of a plurality of residential real estate properties of the same type as the homeowner's property and in a common geographic area as the homeowner's property. An example of such a second contract is described in copending U.S. patent application Ser. No. 10/938,743, filed Sep. 9, 2004, and incorporated herein by reference.

A further security is then created by pooling the second contract with other contracts sold to a second plurality of homeowners, and selling the further security to a further institutional investor in a secondary market. The further institutional investor receives at least a portion of the premium paid by the second plurality of homeowners, and the homeowner receives the fixed cash-settled payout from the further institutional investor if the value of the index has decreased below the predetermined strike threshold between the first time and the expiration date. The homeowner may use the second contract as a hedge to offset potential losses to the homeowner that would result if the homeowner's residential real estate is later sold at a loss.

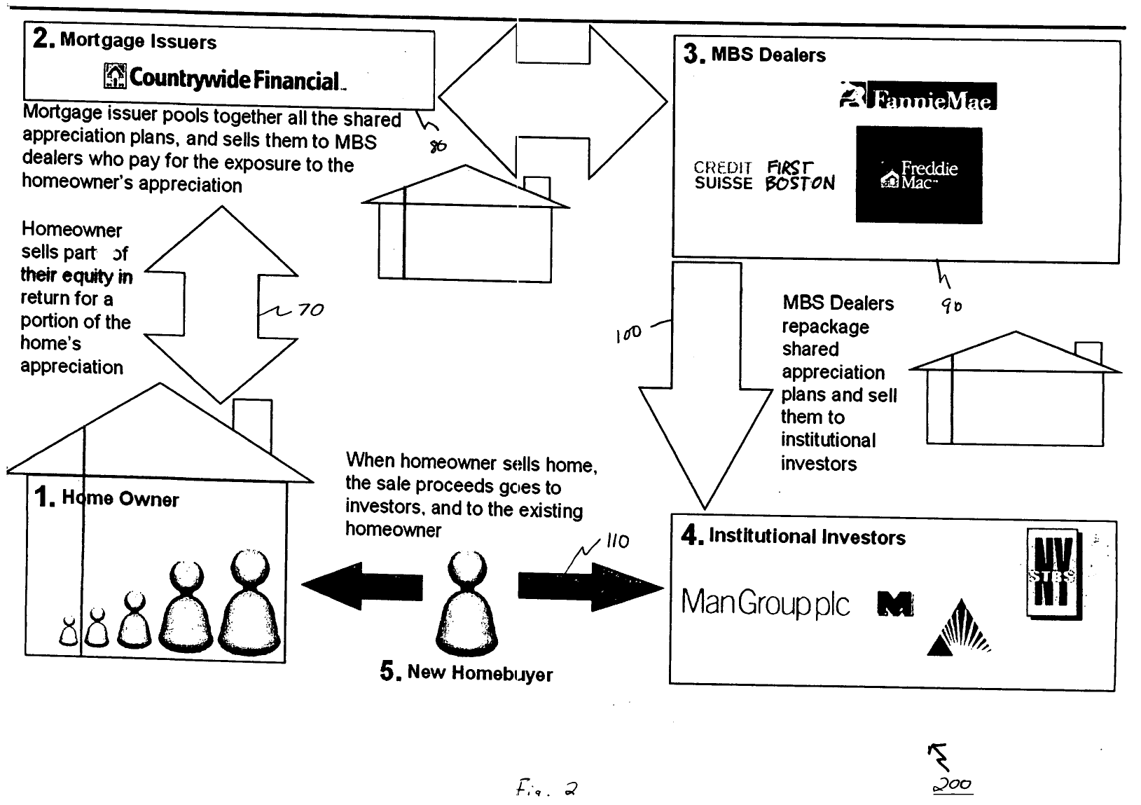

Referring now to FIG. 2, there is shown a schematic of a method for creating, selling and servicing a contract for financing a homeowner's residential real estate property, in accordance with a second embodiment of the present invention. In step 70, a contract is executed between the homeowner and an originator in which the mortgage originator purchases an equity portion of the residential real estate property from the homeowner. In connection with the purchasing, the homeowner grants a lien on the homeowner's residential real estate property to the originator in order to secure a future payment obligation of the homeowner. The future payment obligation has an amount that is determined in accordance with a value of the purchased equity portion of the homeowner's residential real property at a time of the future payment (e.g., when the home is sold). In step 80, a security is created by pooling the contract with other contracts sold to a plurality of other homeowners each of whom owns at least one of a plurality of residential real estate properties. In one embodiment, step 80 is performed by one or more large mortgage issuance providers such as Countrywide Mortgage or Washington Mutual.

In steps 90 and 100, the security is repackaged and sold to an institutional investor in a secondary market. In one embodiment, step 90 is performed by one or more mortgage backed securities issuers such as Fannie Mae or Freddie Mac. The security provides that, upon a sale of each given residential real estate property, the institutional investor has a right to receive a payment 110 corresponding to the value of the purchased equity portion of the given residential real property at the time of the sale. Securities sold in step 100 may be categorized into types according to risk profile, geographic exposure, home price, exposure, duration, etc.

The above specification, examples, and data provide a description of the invention relating to commercial real estate derivatives. Since many embodiments of the present invention can be made without departing from the spirit and intended scope of the invention, the invention resides in the claims hereinafter appended.

What is claimed is:

1. A method for creating, selling and servicing a contract for financing a homeowner's residential real estate property, wherein the homeowner supplies a down-payment to fund a first portion of the purchase price of the homeowner's residential real estate property, a mortgage funds a second portion of the purchase price, and the contract provides equity participation to a contract holder in the homeowner's residential real estate property in return for the contract holder funding a third portion of the purchase price, wherein a total purchase price of the residential real estate property comprises a sum of the first portion, the second portion and the third portion, the method comprising:
(a) executing a contract between the homeowner and a mortgage originator, the contract including at least the following provisions:
(i) a requirement that the homeowner supplies a down-payment to fund the first portion of the purchase price;
(ii) a mortgage for financing the second portion of the purchase price;
(iii) in exchange for the mortgage, a first obligation by the homeowner to make periodic mortgage payments to the contract holder during a period between execution of the contract and a future time;
(iv) an initial equity participation payment supplied by the mortgage originator for funding the third portion of the purchase price; and
(v) in exchange for the initial equity participation payment:
(a) a second obligation by the homeowner to make a future equity participation payment to the contract holder at the future time, the future equity participation payment having an amount comprising the initial equity participation payment plus a predetermined percentage of an increase in value of the residential real estate property between a time of execution of the contract and the future time; and
(b) optionally, a third obligation by the homeowner to make periodic equity participation finance payments to the contract holder during the period between execution of the contract and the future time; and
(iv) at least one lien on the homeowner's residential real estate property granted by the homeowner to the contract holder in order to secure at least one of: the first obligation, the second obligation and the third obligation;
(b) creating a security by pooling rights under the contract with rights under other contracts sold to a plurality of other homeowners each of whom owns at least one of a plurality of residential real estate properties, and selling the security to an institutional investor in a secondary market; wherein the security provides the institutional investor with at least one of: (i) a right to receive the periodic mortgage payments from each of the homeowners, (ii) a right to receive the periodic equity participation finance payments from each of the homeowners; and (iii) for each of the plurality of residential real estate properties, a right to receive the future equity participation payment associated with the residential real property at the time of a future sale of the residential real estate property; and
(c) servicing each of the plurality of contracts included in the security by managing at least one of: the periodic mortgage payments, the periodic equity participation finance payments, and the equity participation payments from the homeowners, wherein the servicing is performed in exchange for a servicing fee.

2. The method of claim 1, wherein the security provides the institutional investor with a right to receive the periodic mortgage payments from each of the homeowners, the periodic equity participation finance payments from each of the homeowners, and for each of the plurality of residential real estate properties, the right to receive the future equity participation payment associated with the residential real property at the time of the future sale of the residential real estate property.

3. The method of claim 1, wherein step (b) comprises:
(b) creating first and second securities by pooling rights under the contract with rights under other contracts sold to a plurality of other homeowners each of whom owns at least one of a plurality of residential real estate properties, and selling the first and second securities, respectively, to first and second different institutional investor in a secondary market; wherein the first security provides the first institutional investor with a right to receive the periodic mortgage payments from each of the homeowners, and the second security provides the second institutional investor with the right to receive the periodic equity participation finance payments from each of the homeowners, and for each of the plurality of residential real estate properties, the right to receive the future equity participation payment associated with the residential real property at the time of the future sale of the residential real estate property.

4. The method of claim 3, wherein after execution of the contract, the homeowner periodically makes a single payment, wherein the single payment includes both one of the periodic mortgage payments and one of the periodic equity participation finance payments, and, in step (c), a servicing agent disburses a portion of the single payment covering the mortgage payment to the first institutional investor and a portion of the single payment covering the equity participation finance payment to the second institutional investor.

5. The method of claim 1, further comprising:
(d) for each of the plurality of residential real estate properties, splitting sale proceeds at the time of the future sale to cover the first obligation and the third obligation of the homeowner of the residential real estate property.

6. The method of claim 1, wherein the homeowner pledges a portion of the homeowner's down-payment in the residential real estate property to the contract holder as security in the event that the homeowner's residential real estate is later sold at a loss.

7. The method of claim 6, further comprising:
(d) purchasing, by the homeowner, a second contract having a premium payable by the homeowner, an expiration date that is a date certain, a predetermined strike threshold, and a fixed cash-settled payout triggered by a reduction in value of an index below the predetermined strike threshold between a first time and the expiration date; wherein the index benchmarks at least one characteristic of a plurality of residential real estate properties of the same type as the homeowner's property and in a common geographic area as the homeowner's property;
(e) creating a further security by pooling the second contract with other contracts sold to a second plurality of homeowners, and selling the further security to a further institutional investor in a secondary market;
(f) wherein the further institutional investor receives at least a portion of the premium paid by the second plurality of homeowners; and
(g) wherein the homeowner receives the fixed cash-settled payout from the further institutional investor if the value of the index decreases below the predetermined strike threshold between the first time and the expiration date.

8. The method of claim 7, wherein the homeowner uses the second contract as a hedge to offset potential losses to the homeowner that would result if the homeowner's residential real estate is later sold at a loss.
